(19) United States
(12) Patent Application Publication
(10) Pub. No.: US 2013/0133691 A1
(43) Pub. Date: May 30, 2013

(54) METHOD OF CLEANING TUNGSTEN PLUG SURFACES IN ULTRA LARGE SCALE INTEGRATED CIRCUITS AFTER CHEMICAL-MECHANICAL POLISHING

(71) Applicant: HEBEI UNIVERSITY OF TECHNOLOGY, Tianjin (CN)

(72) Inventors: Yuling LIU, Tianjin (CN); Xinhuan NIU, Tianjin (CN); Chenwei WANG, Tianjin (CN); Yangang HE, Tianjin (CN)

(73) Assignee: HEBEI UNIVERSITY OF TECHNOLOGY, Tianjin (CN)

(21) Appl. No.: 13/737,975

(22) Filed: Jan. 10, 2013

Related U.S. Application Data
(63) Continuation-in-part of application No. PCT/CN2010/080472, filed on Dec. 30, 2010.

(30) Foreign Application Priority Data
Jul. 21, 2010 (CN) 201010231680.X

(51) Int. Cl. B08B 3/08; C23G 1/06

(52) U.S. Cl. CPC B08B 3/08
USPC 134/2

(57) ABSTRACT

A method of cleaning tungsten plug surfaces in ultra large scale integrated circuits after chemical-mechanical polishing, the method including: a) preparing a cleaning solution by mixing deionized water, between 15 and 30 g/L of an active agent with respect to the deionized water, between 5 and 20 g/L of a chelating agent with respect to the deionized water, and between 1 and 60 g/L of a corrosion inhibitor with respect to the deionized water; b) after alkaline chemical-mechanical polishing, washing the tungsten plug surfaces using the cleaning solution at a flow rate of between 1000 and 4000 g/min for between 30 s and 3 min.

### CROSS-REFERENCE TO RELATED APPLICATIONS

This application is a continuation-in-part of International Patent Application No. PCT/CN2010/080472 with an international filing date of Dec. 30, 2010, designating the United States, now pending, and further claims priority benefits to Chinese Patent Application No. 201010231680.X filed Jul. 21, 2010. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a method of cleaning tungsten plug surfaces in ultra large scale integrated circuits (hereinafter refer to as ULSIs) after chemical-mechanical polishing (hereinafter refer to as CMP).

2. Description of the Related Art

Currently, as the number of wiring layers is increasing and each layer is required to be flat, CMP is the only method by which the whole flattening can be realized. However, CMP for tungsten involves a series of complicated chemical and mechanical reactions, which are affected by many parameters, such as press, temperature, pH value, and so on, and relate to metal physics, solid state physics, materials science, and microelectronic technology, and so on, many of which have theoretical issues to be solved.

Tungsten has a good anti-electron mobility, hillock free, low stress under conditions of high current density, and has a good ohmic contact with silicon, thus, it can be used as a filler metal and diffusion barrier of contact windows and via holes. Each layer is required flattening in multilayer wirings with a minimum feature size of 0.35 μm and below. CMP is so far the only and the most advanced technology by which the whole flattening can be realized. Tungsten residues outside via holes of multilayer wirings must be treated by CMP, only a whole flattening is achieved, the next layer can be wired, otherwise, disconnection of wires may occur which may result in serious consequence. Thus, the whole flattening of the surface is one of fundamental and critical techniques in multilayer wirings.

The use of polishing solution is especially important in CMP of high precision processing of ULSIs. Currently, tungsten plugs after polishing has high surface energy, large surface tension, uneven distribution of polishing solution residues, and contaminating metal ions, all of which improve the production cost and lower yields in later processing.

### SUMMARY OF THE INVENTION

In view of the above-described problems, it is one objective of the invention to provide a method of cleaning tungsten plug surfaces in ULSIs after CMP. The method has easy operation and pollution free.

To achieve the above objective, in accordance with one embodiment of the invention, there is provided a method of cleaning tungsten plug surfaces in ULSIs after CMP, the method comprising:
a) preparing a cleaning solution: mixing deionized water, between 15 and 30 g/L of an active agent with respect to the deionized water, between 5 and 20 g/L of a chelating agent with respect to the deionized water, and between 1 and 60 g/L of a corrosion inhibitor with respect to the deionized water; and
b) after alkaline CMP, washing the tungsten plug surfaces using the prepared cleaning solution at a flow rate of between 1000 and 4000 g/min for between 30 s and 3 min

In a class of this embodiment, the active agent is an FA/O surfactant, O_{π}-7 ((C₁₀H₂₁-C₆H₄—O—CH₂CH₂O)₇-H), O_{π}-10 ((C₁₀H₂₁-C₆H₄—O—CH₂CH₂O)₁₀-H), O-20 (C₁₂₋₁₈H₂₅₋₃₇-C₆H₄—O—CH₂CH₂O)₇₀-H), or polyoxyethylene secondary alkyl alcohol ether (JFC).

In a class of this embodiment, the chelating agent is tetra(THEED)-EDTA, i.e., the tetra (N,N,N′,N′-tetrakis(2-hydroxyethyl)ethylenediamine) salt of ethylenediaminetetraacetic acid, the structural formula of which is as follows:

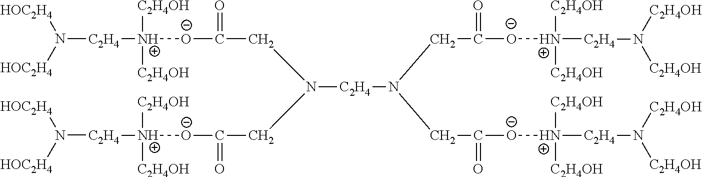

In a class of this embodiment, the corrosion inhibitor is hexamethylenetetramine or benzotriazole, the molecular formula of hexamethylenetetramine is C₆H₁₂N₄, and the structural formula thereof is

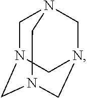

the molecular formula of benzotriazole is C₆H₅N₃, and the structural formula thereof is

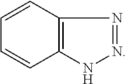

Effects of the invention are summarized below:
After alkaline CMP, tungsten plugs have such problems as high surface energy, large surface tension, uneven distribution of polishing solution residues, adsorption of metal ions, and so on. Once the alkaline CMP is accomplished, the surfactant, chelating agent, corrosion inhibitor are added into the cleaning solution, and a large flow rate of the cleaning solution is employed to wash away residues of polishing solution which may react with local parts of surface, and at the same time to quickly lower the surface tension through physical adsorption of easily removable matters, to form a single molecular passive film preventing local corrosion, and to make metal ions form soluble chelates, thereby obtaining a clean and perfect surface.

Advantages of the invention are summarized below:
1. The washing after CMP employs a cleaning solution containing a surfactant, a chelating agent, a corrosion inhibitor, and others to clean tungsten plug surfaces at a large flow rate, which has no corrosion to devices and washes away polishing solution residues unevenly distributed on the wafer surface, thereby obtaining a clean and perfect surface.
2. The surfactant quickly lowers the high surface tension of wafers, reduces damaged layers, and improves the evenness of the surface.
3. The chelating agent reacts with residues of metal ions to yield macromolecular chelates, thus, metal ions are washed away from tungsten plug surfaces with large flow rate of the cleaning solution.
4. The corrosion inhibitor forms a single molecular passive film on the surface to prevent residues of polishing solution from continuing reacting with the surface and from forming uneven corrosion and oxidation, so that the perfection of the wafer surface is improved. Furthermore, the surface has no etching circles, and the roughness can be lowered to a nano degree.
5. Comprehensive effects of embodiments are exemplified as follows:

| Treatment | | Treatment | |
|---|---|---|---|
| after CMP | Effects | after CMP | Effects |
| No washing | Etching circles on | Method of | No etching circles |
| | the surface, 23 nm | the invention | on the surface, 9 nm |
| | roughness | | roughness |
| Washing | Etching circles on | Method of | No etching circles |
| without | the surface, 14 nm | the invention | on the surface, |
| surfactant, | roughness | | 6.43 nm |
| chelating | | | roughness |
| agent, and | | | |
| corrosion | | | |
| inhibitor | | | |

### DETAILED DESCRIPTION OF THE EMBODIMENTS

To further illustrate the invention, experiments detailing a method of cleaning tungsten plug surfaces in ULSIs after CMP are described below. It should be noted that the following examples are intended to describe and not to limit the invention.

### EXAMPLE 1

Preparation of 4000 g of a water soluble cleaning solution for tungsten plugs:

3645 g of deionized water was mixed and stirred with 100 g of an FA/O surfactant, 50 g of an FA/O chelating agent, and a diluent having 5 g of hexamethylenetetramine and 200 g of deionized water. Subsequently, 4000 g of a cleaning solution for tungsten plugs was collected.

Tungsten plugs was washed using the cleaning solution at a flow rate of 1000 g/min. The resulting surface had no corrosion circles, and the roughness was 7.8 nm

### EXAMPLE 2

Preparation of 4000 g of a water soluble cleaning solution for tungsten plugs: 3400 g of deionized water was mixed and stirred with 100 g of an O₉₀-7 surfactant, 50 g of an FA/O chelating agent, and a diluent having 250 g of benzotriazole and 200 g of deionized water. Subsequently, 4000 g of a cleaning solution for tungsten plugs was collected.

Tungsten plugs was washed using the cleaning solution at a flow rate of 4000 g/min. The resulting surface had no corrosion circles, and the roughness was 6.4 nm

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method of cleaning tungsten plug surfaces in ultra large scale integrated circuits after chemical-mechanical polishing, the method comprising:
a) preparing a cleaning solution by mixing deionized water, between 15 and 30 g/L of an active agent with respect to the deionized water, between 5 and 20 g/L of a chelating agent with respect to the deionized water, and between 1 and 60 g/L of a corrosion inhibitor with respect to the deionized water; and
b) after alkaline chemical-mechanical polishing, washing the tungsten plug surfaces using the cleaning solution at a flow rate of between 1000 and 4000 g/min for between 30 s and 3 min.

2. The method of claim 1, wherein the active agent is an FA/O surfactant, O₉₀-7 ((C₁₀H₂₁-C₆H₄-O—CH₂CH₂O)₇-H), O₉₀-10 ((C₁₀H₂₁-C₆H₄—O—CH₂CH₂O)₁₀-H), O-20 (C₁₂₋₁₈H₂₅₋₃₇-C₅H₄-O-CH₂CH₂O)₇₀-H), or JFC.

3. The method of claim 1, wherein the chelating agent is

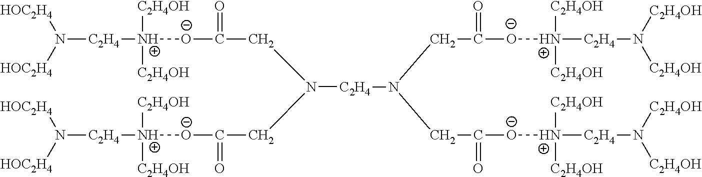

4. The method of claim 1, wherein the corrosion inhibitor is hexamethylenetetramine or benzotriazole.
